(19) United States
(12) Patent Application Publication
(10) Pub. No.: US 2014/0122190 A1
(43) Pub. Date: May 1, 2014

(54) SYSTEM AND METHODS FOR DETECTION AND SELECTION OF A RESOURCE AMONG AVAILABLE RESOURCES

(71) Applicants: Ouri Wolfson, Chicago, IL (US); Leon Stenneth, Chicago, IL (US); Bo Xu, Lisle, IL (US); Daniel Ayala, Chicago, IL (US); Bhaskar DasGupta, Arlington Heights, IL (US); Jie Lin, Chicago, IL (US)

(72) Inventors: Ouri Wolfson, Chicago, IL (US); Leon Stenneth, Chicago, IL (US); Bo Xu, Lisle, IL (US); Daniel Ayala, Chicago, IL (US); Bhaskar DasGupta, Arlington Heights, IL (US); Jie Lin, Chicago, IL (US)

(21) Appl. No.: 14/068,307

(22) Filed: Oct. 31, 2013

Related U.S. Application Data
(60) Provisional application No. 61/720,758, filed on Oct. 31, 2012.
(60) Provisional application No. 61/720,815, filed on Oct. 31, 2012.
(60) Provisional application No. 61/856,453, filed on Jul. 19, 2013.

(51) Int. Cl. G08G 1/14; G07B 15/00

(52) U.S. Cl. CPC G08G 1/144; G07B 15/00
USPC 705/13; 340/932.2

(57) ABSTRACT

Detecting whether a resource is available and facilitating the selection of a resource from a set of resources, some of which may be available or unavailable at any given time can be a challenge. One such resource is a suitable place to park a vehicle including automobile, motorcycle, and bicycle. Finding parking can be a significant challenge in population dense environments. Certain embodiments of the present invention are configured to assist users with quickly and efficiently finding a parking slot near his or her location or destination. The system may be configured to generate parking slot suggestions based on one or more of a wide range of individual or group preference criteria. Advantageously, facilitating quick and efficient parking reduces traffic congestion and pollution.

### CROSS REFERENCE TO RELATED PATENTS

This application claims the benefit of U.S. Provisional Application No. 61/720,758 filed Oct. 31, 2012, U.S. Provisional Application No. 61/720,815 filed Oct. 31, 2012, and U.S. Provisional Application No. 61/856,453 filed Jul. 19, 2013, each of which is incorporated by reference herein in its entirety.

### STATEMENT REGARDING FEDERALLY SPONSORED RESEARCH

This invention was made with government support under DGE-0549489, CNS-1115234, DBI-0960443, IIS-1213013, IIP-1315169, and CCF-1216096 awarded by the National Science Foundation or the U.S. Department of Transportation National University Rail Center. The government has certain rights in the invention.

### FIELD OF THE INVENTION

The present invention relates generally to detecting whether a resource is available and facilitating the selection of a resource from a set of resources, some of which may be available or unavailable at any given time.

### BACKGROUND OF THE INVENTION

The present invention is applicable to the detection of the availability of and selection of any resource from a set of resources, when, at any given time, one or more of the resources may be available or unavailable and the status of the availability may change over time. Resources to which the present invention may be applicable include parking slots, elevators, stairways, hallways, walkways, restroom stalls, rides at amusement parks, handicap accessibility features, “share-bikes”, share-bike slots, electric car charging stations, taxi cabs, taxi-cab customers, food carts or food trucks, restaurants including seats at counters and tables, stores, and fueling stations to name a few. Such resources may be “serial”—in which only one user can use one of the resources from a set of resources at one time—or “non-serial”—in which more than one user can use one of the resources from a set of resources at a given time. For purposes of this application, the present invention is discussed in reference to detecting and selecting a parking slot, but the discussion is merely exemplary.

Finding a parking slot for a vehicle can be challenging in urban environments or other population-dense environments—such as stadiums, fairs, amusement parks, tourist destinations, or other event venues—, airports, train stations, bus station, or other transportation hubs, hospitals, hotels, apartment/condo buildings, or office buildings, to name a few. Indeed, one estimate suggests that some 8.37 million gallons of gasoline were consumed and 129,000 tons of carbon dioxide were produced by vehicles in one city, just during the search for parking slots. In addition to causing pollution and waste of fuel, searching for parking slots also increases traffic congestion and driver frustration. In major cities, it is estimated that 30% of congestion is due to drivers looking for parking.

Many people wish to, not only find a parking slot efficiently, but also maximize the slot selection according to certain preference criteria. Examples of preference criteria include distance from current location, distance from destination, time to get to parking slot (possibly taking into account current traffic conditions), or price associated with parking.

The first step in helping users select a preferred parking slot (as determined by any combination of one or more of the above preference criteria) may include finding the locations of parking slots and then identifying which parking slots are unoccupied or occupied. Certain systems and methods have been developed to assist with locating unoccupied parking slots. However, a variety of disadvantages are associated with such known systems and methods.

For example, certain parking systems include a device positioned at one or more ingress/egress points around an area having parking slots to track how many vehicles enter or exit the parking area. Based on the assumption that each vehicle takes up only one parking slot, the device can then calculate how many unoccupied slots remain in the defined parking area. This device has limited applicability in that it can function as intended if the parking slots are not located in a confined area having just one or a few ingress/egress points.

Another known system includes a fixed car detection sensor positioned in or near every parking slot or at least certain parking slots among a set of parking slots. However, implementation of such systems is often cost-prohibitive. For example, one such system was implemented in only portions of an urban environment for a cost of over $23 million U.S. dollars.

Rather than positioning devices in the actual parking slot to detect the presence or absence of a vehicle, other known systems rely on a device fixed to each vehicle. One such vehicle-mounted device may be configured to track the location of the vehicle and, by comparing the vehicle location to the location of parking slots, determine whether the vehicle is occupying a parking slot. Such known vehicle-mounted devices include a global positioning system (GPS)-based location unit and a small personal computer (PC) with a WIFI card. Another vehicle-mounted device includes an ultrasonic sensor that detects whether a vehicle is parked, for example, at a curb or not and transmits that information to one or more users to determine whether a parking space along the curb is available. Even though such a device permits identifying whether parking slots are occupied or unoccupied, installing (or retrofitting) each and every vehicle with such a device may be cost-prohibitive. Also with respect to the ultrasonic device, if only a few vehicles include the device, the system has limited functionality coverage.

Another major drawback with certain conventional systems for locating parking slots is that they are configured to identify only street parking slots that are designated as such and do not incorporate private parking facilities including garages and lots that may be available not only on a full time basis but those that are available on a temporary basis (such as parking available on the “day of the game” only).

Some known systems inform the user whether parking slots are available according to the street addresses relative to the parking slots. However, if the user is unfamiliar with the area, the user may not know how to get to the identified by the address and therefore will need to take one or more steps of trying to find the location of the slot.

Other known systems may, in addition to identifying addresses, utilize displays to provide users with illustrations showing available parking slots relative to some type of map. Such systems, however, may not rank the slots according to one or more standards or criteria such as shortest driving distance or shortest driving time (and thereby according to efficiency) or desirability of the respective slots. As a result, the user is left to select among the unranked choices based on the user's knowledge or simply choose one of the displayed options at random. Some known systems permit the user to select a limited scope and types of preference criteria, such as closeness to a destination or size of the parking slot. Also, some known methods for assisting users with identifying a parking slot are limited to seeking to find the most preferred slot from the perspective of each user. However, a certain slot may be the most preferred slot for two users at the same time. If both users are directed to the slot, only one will be able to actually park in the slot. The other user has wasted resources attempting to get to that slot. Clearly, such systems do not maximize use of parking slots for a group of users.

Clearly, there is a demand for an advanced system and methods for identifying the availability of a resource such as a parking slot and providing a suggestion for selecting a resource according to a wide range of user preferences. The present invention satisfies this demand.

### SUMMARY OF THE INVENTION

Certain embodiments of the present invention are configured to assist a user with selecting a parking slot, for example, in a crowded environment. For purposes of this application, the term “user” means a person accessing the system and methods. A user may include a person planning to drive or currently driving a vehicle—e.g., driver—, a passenger in a vehicle, or someone positioned remotely that is assisting a driver or passenger. The terms “user”, “driver”, and “passenger” will be used synonymously in this application.

In order to process requests from users, the system first obtains information about where parking slots are located. Once located, the parking slots are grouped to form a set of parking slots. Each set may include all the parking slots on one entire block (all three or four sides of the block), one street of a block, two adjacent blocks, one neighborhood, or parking slots in a small area having a similar characteristic such as fee required, permit required, or size. The parking slots assigned to each set may be physically adjacent to one another or may have gaps between them. Typically, all of the parking slots within the system are assigned to one of at least two or more sets. Next, the system receives information about whether certain parking slots or sets of parking slots are available at certain times and dates. The availability information may include whether the slot is occupied or not, and whether there are any legal restrictions for parking in the slot at that given time (e.g., some parking slots are restricted between certain hours of the day, certain days a week, or periodically, for example, for street sweeping). This availability information may be obtained from other users (via detection elements) or from other sources.

Parking availability information may be estimated or determined from one or more sensors including motion sensors, acoustic sensors, short-range communication sensors. Parking availability information may also be estimated by using historical data, determined from contemporaneous data—including that obtained regarding payments made for parking—, or a combination of both. Time expiration for parking can be used to estimate whether deparking will likely occur soon or has occurred. Additionally, information regarding “find-my-car” requests also can provide an indicator whether deparking activity will soon occur or has occurred. This information may be used for purposes of determining whether one or more, including an associated group of slots may be or is available.

Based on this background information about availability of parking slots, the system develops a historical availability profile for each set of parking slots.

Later, a user fills out and submits a request for a parking slot suggestion via the user interface. The user interface may include number of fields configured to permit the user to input a wide variety of preference criteria about the parking slot. (For example, that the parking slot is near a destination address, the parking slot has no fee associated with it, or the parking slot is covered, to name a few.) Instead of or in conjunction with inputting the location near which the user wishes to find a preferred parking slot, the system may also identify the current location of the user (e.g., using a GPS-based location unit). Upon receipt of a user's request to display a parking slot suggestion, the system seeks to identify a parking slot nearby the user's current location or destination.

More specifically, when a system seeks to identify an available parking slot for a user or an set of parking slots in which there is likely to be at least one available slot, the system may generate what is termed a “parking availability estimation” for each set of parking slots. The parking availability estimation is an assessment of the likelihood that the user will find an unoccupied parking slot either at the current time, at the time that the user selects, or at the time the user will likely be near the destination. The assessment is generated using the historical availability profile for that set of parking slot and, possibly, any real-time detected information received by the system.

The historical availability profile may include the mean and variance of parking availability for a single slot or a selected set of parking slots (also termed a “group” for purposes of this application). In certain embodiments, the historical availability profile may include the probability that at least one parking slot is available within a set of parking slots. In certain embodiments, the historical availability profile may include the mean and variance of a random variable representing the number of slots available in the group. In certain embodiments, the historical availability profile may include a scaled decrease of the parking availability if the system does not have complete market penetration (e.g., some people who are parking in an area are not reporting information to the system). Also, in certain embodiments, a scaled increase may be added to the parking availability value because some false positive reports (e.g., system detected that a vehicle was parked, yet no vehicle was actually parked) may have been received by the system. The starting step, incorporating step, and, if applicable, adding step are repeated for a number of additional time points until a certain confidence level (e.g., 95%) for the accuracy of the result is reached. Accordingly, a historical availability profile is produced. The “parking availability estimation” may be computed using one or more estimation methods. For purposes of this application, one method—termed the “Historical Statistics” method—may generally utilize the estimated historical mean of parking availability based on past detected parking slot usage. Another method—termed the “Scaled PhonePark” method—may begin with detected information received from users (via detection elements) and scale that information to the entire set of parking slots based on the system penetration ratio and detection accuracy. A third method—termed the “Weighted Average” method for purposes of this application—includes the computing of a weighted average of the historical mean and the scaled detected information from users. The optimal weight for each of the historical mean (signified by w_{HS}) and the scaled detected information from users (signified by (1−w_{HS}) is optimized based on the parameters such as penetration ratio of the system users. The fourth method—termed a “Kalman Filter” method for purposes of this application—uses a second type of weighted average of the historical mean and the scaled detected information from users, where the Kalman filter known in the art is applied in the calculation.

These methods may be altered if necessary to incorporate the user's preference criteria into the parking availability estimation. Additionally, methods to determine possible current availability of parking include considerations of location inaccuracy and statistical correlation among the parking slot sets. Alternatively, using the parking availability estimation, supplemental steps are performed to account for additional preference criteria to create a “desirability score” for each parking slot or set of parking slots.

From the parking availability estimation or desirability score, the system may rank each set of parking slots relative to the user's preference criteria. For example, the higher the rank, the more closely the set of parking slots matches the user's preference criteria. The highest ranked set of parking slots is the “most preferred” set of parking slots.

To display the one or more most preferred sets of parking slots, the system of the present invention may include a parking suggestion screen (as part of a user interface) configured to be displayed via an output element. An output element may be, for example, a mobile device. The parking suggestion screen may include many types of information. For example, the parking suggestion screen may indicate only the single most highly preferred set of parking slots on a map. A “suggestion indicator” (e.g., a star, “X”, certain color block, or other symbol) may be illustrated on a map to show the most highly ranked set of parking slots. A map also may include a “status indicator” (e.g., a color or representation for each status) configured to communicate which specific parking slots are reported to be occupied or unoccupied.

The parking suggestion screen also may show a map illustrating a few choices of highly preferred sets of parking slots, a list of a single highest ranked set of parking slots or top few choices of sets of parking slots, or a non-map graphical representation of the single highest ranked set of parking slots or top few sets of parking slots. In embodiments in which the results screen shows more than one parking slot, each parking slot may be ranked according to one or a combination of user's preference criteria.

Also, using the parking availability estimation or desirability score, the system may prepare one or more routes to the most preferred set of parking slots or the top few most preferred sets of parking slots. The routes may be displayed relative to a map or a list of directions (e.g., turn onto street one, continue X miles, turn onto street two, etc.). Certain embodiments of the present invention may include an audible output such as audible directions to the area in which the highest ranked set of parking slots are located.

As described above, in certain embodiments, the present invention is configured to identify a parking slot for a single user based on the user's preferences and without regard for any other users of the system.

The user may enter the preference criteria for each search for a parking slot. Or, the user may create a user profile and save the preference criteria for all searches entered via that user's profile. The user interface may include one or more preference criteria fields configured to receive such information.

In certain embodiments, a user may input only one preference criterion to be applied in the calculation of the user's most preferred slot, while in other embodiments, a user may input any number of preference criteria. In embodiments in which multiple preference criteria can be entered, each criterion may have equal value relative to the others or each criterion may be rated in order of importance by the user. Also, certain criterion could be designated as “required” and other criterion could be designated as “optional, but desired”.

As described above, a user's preference criteria may include distance from current location, distance from destination, time to get to parking slot (possibly taking into account current or historically or statistically anticipated traffic conditions), or price associated with parking. Certain embodiments of the present invention also permit a user to input one or more additional preference criteria, including handicapped accessibility, walkability of area in which parking slot is located, size of the slot (size for motorcycle vs. compact car vs. sports utility vehicle vs. semi-truck), security of the slot (e.g., presence of a fence around or guard near the parking lot), safety of the slot (e.g., distance from a high crime area, number of break-ins nearby), likelihood that slot will be unoccupied by the time the user reaches the parking slot, likelihood that a number of slots will still be unoccupied by the time the user reaches a group of parking slots, whether a permit is needed for the slot (and whether the user has that type of permit), proximity to other modes of transportation (e.g., trains, planes, subway, buses, etc.), whether short-term or long-term parking is permitted (e.g., depending on whether user is planning to park for a number of minutes, hours, or days), or whether the slot is covered or uncovered (which may be especially beneficial in adverse weather conditions such as rain, hail, snow, or extreme heat).

While certain embodiments are configured to rank sets of parking slots for the user based on only that specific user's preference criteria, other embodiments are configured to maximize the slot selection for a group of two or more users. Such embodiments incorporate group preference criteria, which may include maximizing the parking slot usage by all users as calculated by the lowest distance traveled for the group of users (not each individual user separately), lowest CO₂ emissions for the group of users, or lowest traffic congestion. In such embodiments, the system displays a suggested set of parking slots for each user to maximize the group use of the unoccupied parking slots.

In certain embodiments configured to manage group use of a set of unoccupied parking slots, the system is configured to dynamically establish the fee for each parking slot. Clearly, in such embodiments, a resource payment element (described in more detail below) is either in communication with the system or a part of the system. Such embodiments may be controlled by or at least authorized by a central authority, e.g., an owner of a parking structure or other set of parking slots, city, town, municipality, co-op, or a group of users that has agreed to permit the system to select the fee for the parking slot. The fee level may encourage users to drive to a parking slot that may be ranked lower according to their personal preferences, but ranked higher according to the group preferences.

One object of certain embodiments of the present invention is to permit a user to identify an unoccupied parking slot nearby a destination quickly and easily.

Another object of certain embodiments of the present invention is to rank parking slots based on a user's personal preferences criteria.

Another object of certain embodiments of the present invention is to rank parking slots based on a user's personal preferences criteria in light of the preference criteria of other users.

Another object of certain embodiments of the present invention is to rank parking slots based on a user's preference criteria in light of current conditions (e.g., weather, time of day, time of year, holiday, etc.).

Another object of certain embodiments of the present invention is to reduce the time that users drive around looking for a parking slot.

Another object of certain embodiments of the present invention is to minimize traffic congestion.

Another object of certain embodiments of the present invention is to decrease the CO₂ emissions from vehicles.

Another object of certain embodiments of the present invention is to provide an interface through which a wide range of preference criteria can be entered and applied to the ranking of parking slots.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates an embodiment of a system of the present invention;

FIG. 2 illustrates another embodiment of a system of the present invention;

FIG. 3 illustrates an additional embodiment of a system of the present invention;

FIG. 4A illustrates another embodiment of a system of the present invention;

FIG. 4B illustrates an additional embodiment of a system of the present invention;

FIG. 5 illustrates a scenario including two vehicles and two parking slots;

FIG. 6A illustrates a method embodiment of the present invention;

FIG. 6B illustrates another method embodiment of the present invention;

FIG. 6C illustrates an additional method embodiment of the present invention;

FIG. 6D illustrates a further method embodiment of the present invention;

FIG. 7 illustrates a computer system according to the present invention;

FIG. 8 illustrates a cloud computing system according to the present invention;

FIG. 9 illustrates an embodiment of a user interface according to the present invention;

FIG. 10A illustrates another embodiment of a user interface according to the present invention;

FIG. 10B illustrates an additional embodiment of a user interface according to the present invention;

FIG. 11 illustrates an embodiment of a user interface that facilitates the selection of the communication system that will be monitored;

FIG. 12A illustrates an embodiment of a user interface that facilitates the entry by a user of preference criteria;

FIG. 12B illustrates an additional embodiment of a user interface that facilitates the entry by a user of preference criteria;

FIG. 13 illustrates an embodiment of a user interface by which directions may be provided to a user in a free competition configuration;

FIG. 14 illustrates an embodiment of a user interface by which directions may be provided to a user for parking in a parking lot;

FIG. 15 illustrates an embodiment of a user interface in which details regarding the parking is provided; and

FIG. 16 illustrates an embodiment of a user interface by which directions may be provided to a user that include price information.

### DETAILED DESCRIPTION OF EMBODIMENTS OF THE INVENTION

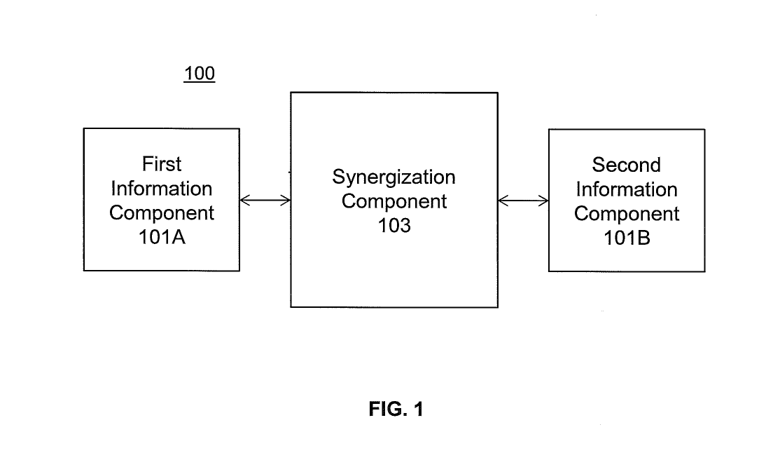

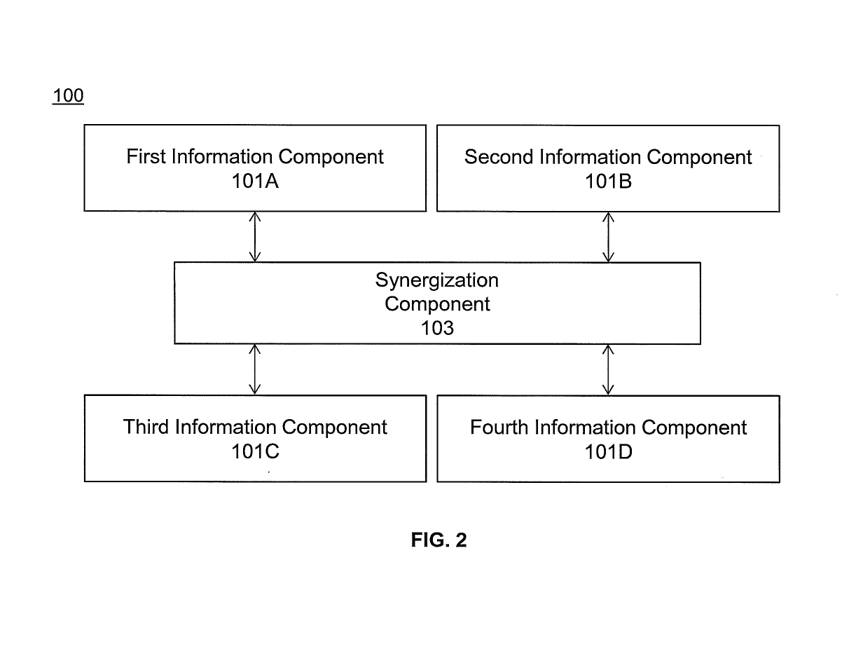

FIG. 1 illustrates a certain embodiment of the system 100 and methods 200 of the present invention that includes one or more resource information components 101 and a synergization component 103. Each system 100 may have any number of resource information components 101. An embodiment including four user resource information components 101A, 101B, 101C, and 101D is illustrated in FIG. 2.

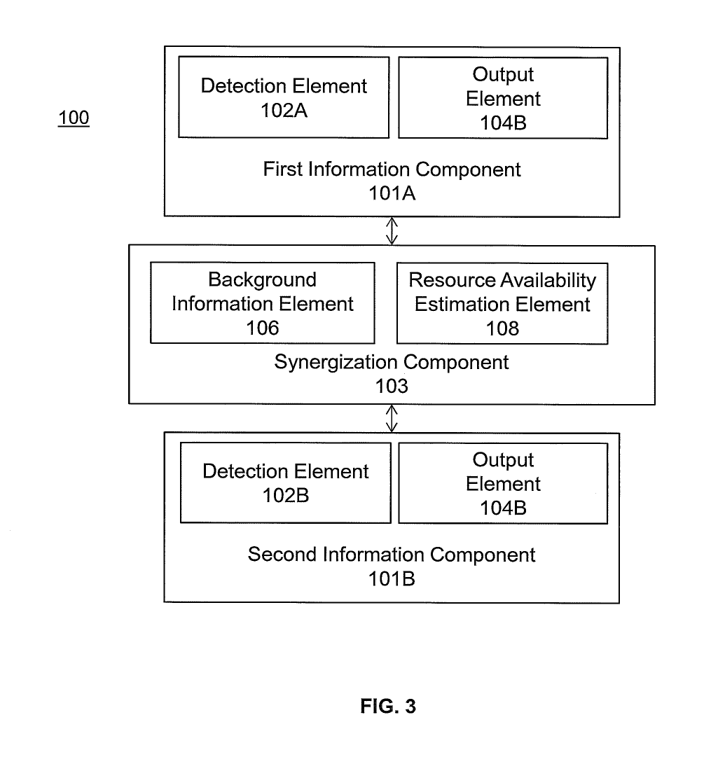

Each resource information component 101 is configured to permit gathering, storing, and communicating information about the resources and, more specifically, the availability of each particular resource. For example, an information component 101 may be configured to obtain information to permit classifying a parking slot as “occupied” or “unoccupied”. To achieve this classification and then display such information, certain embodiments of a resource information component may include a detection element 102 for identifying or receiving information about the availability of the parking slot and an output element 104 to display the status, as illustrated in FIG. 3.

Each resource information component 101 may be configured to send the detected information or classification of the parking slot to a synergization component 103. The synergization component 103 may be configured, for example, to store parking slot status information, including the appropriate classification itself (for example, occupied or unoccupied) and, possibly, the time and date of any change in the classification. The synergization component may then distribute information about the parking slots to other users.

More specifically, by using the detected information gathered by the detection elements 102 or background information about availability of a parking slot or a certain set of parking slots, the synergization component 103 may generate a historical availability profile for each parking slot or a set of parking slots. The historical availability profile may include computing the mean and variance of parking availability for a selected group of parking slots.

Using the historical availability profile and possibly additional real-time detected information, the system may statistically produce a “parking availability estimation”—that is, an up-to-date prediction regarding the availability of a parking slot within a set of parking slots. The historical availability profile may be updated on a rolling basis to emphasize information received more recently and deemphasize older information or may be generally static once established. Advantageously, the system 100 does not need to detect the availability of every single parking slot to provide a highly accurate prediction.

Additional details about the elements of a resource information component 101 and a synergization component 103 are provided below.

As described above, certain embodiments of a resource information component 101 include a detection element 102, which may be configured to detect information related to whether a vehicle is positioned in a parking slot or whether a vehicle is likely to be positioned in a parking slot at a certain time. In general, a detection element 102 may be configured to detect information about a user that can be related to the position of a vehicle such as when the user is in the vehicle. Such embodiments are termed “user detection elements” for purposes of this application. A detection element 102 may be configured to directly obtain information about a vehicle. Such embodiments are termed “vehicle detection elements” for purposes of this application. A detection element may be configured to directly obtain information about a resource such as a parking slot. Such embodiments are termed “resource detection elements”. A single detection element 102 may include one or more of a user detection element, vehicle detection element, and resource detection element. More detail about each of these embodiments is provided below.

Certain embodiments of a user detection element may be configured to be adjacent to, positioned on, or carried around by a user. A user detection element may be configured to actively or passively detect information about the user and possibly the user's vehicle.

An active user detection element may be configured to permit a user to actively input information into the system. Such embodiments may include a user interface including one or more input fields for the user to input information about their vehicle or about a parking slot. For example, a user interface may include a planned vehicle use field configured to permit the user to input driving plans to a certain destination at a certain time and place or, more specifically, that they plan to park in a certain slot from a start time to an end time. A user interface may have separate fields for start time and end time such that the user may submit the start time first, and then later, submit an anticipated end time.

In certain embodiments, the active user detection element may extract the destination information, start time information, and end time information from a calendar program, possibly also stored within the same device or otherwise accessible to the active user detection element.

An active user detection element may include a user interface configurable also to permit a user to input availability information about parking slots. Such embodiments may include rewards (e.g., points or coupons) for entering information about parking slots, even if the user is not actually using those parking slots. For example, a user who is walking down a street may observe and input their observations about the status of one or more parking slots on that street. The observation may be in the form of parking slots unoccupied per block or whether each parking slot is occupied or unoccupied.

Other user detection elements may be configurable to collect information passively. A passive user detection element may collect information without requiring the user to directly input the information. The passive user detection element may be pre-programmed to gather the desired information.

A user detection element may be formed in or formed by one or more of a smartphone, cellular phone, pager, position detection element, location detection element, latitude/longitude detector, computer system (described in more detail below), or other personal or mobile device. In certain embodiments, a user detection element 102 may include a smartphone having at least a position detection element and a location detection element.

For purposes of this application, a “position detection element” may include an accelerometer, a camera, a motion detector, gyroscope, or other device configured to measure information about the position of the user detection element. An accelerometer is a device configured to measure acceleration.

For purposes of this application, a “location detection element” is configured to detect location of a device, such as a user detection element. A “location” is the geographic place, or in other words, the point on the surface of the Earth or other planet relative to other points.

A location detection element may use triangulation, trilateration, or multilateration to determine the location of a subject. Certain embodiments of a location detection unit may include, for example, a GPS-based location unit; WiFi-based location unit; Bluetooth-based location unit; or other type of network-based location unit; cell tower-based location unit or other handset-based location unit; radio broadcast tower-based unit or other SIM-based location unit; or hybrid location unit.

A GPS-based location unit is configured to receive information about its location, such as geographic coordinates for longitude and latitude on Earth from a satellite. A GPS-based location unit may access satellite systems such as governmental GPS satellites, GLONASS, and other systems. A GPS-based location unit may include a GPS sensor and a GPS trace.

Certain embodiments of a WiFi-based location unit utilize what is termed “location fingerprinting”. Specifically, a WiFi-based location unit may be configured to ascertain location information by assessing the strength of a signal coming from wireless access points and, based on the signal strength, calculating the distance from such wireless access points to determine the location of the unit.

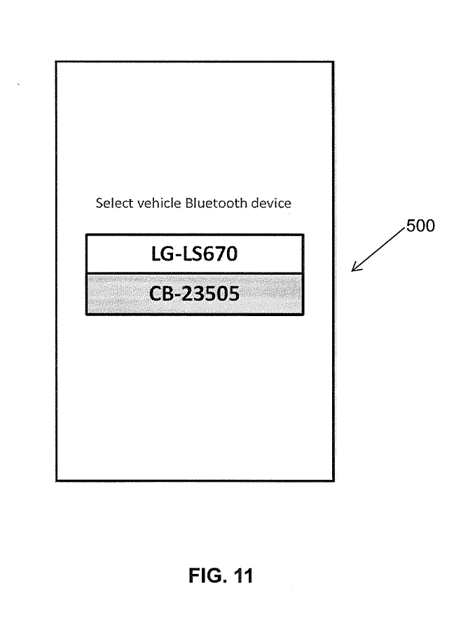

A Bluetooth-based location unit is configured to use Bluetooth technology for exchanging location information over short distances to permit calculation of the location of the device. FIG. 11 illustrates a user interface 500 that permits a user to select the vehicle Bluetooth device that will be monitored for Bluetooth connectivity detection.

A cell tower-based location unit is configured to receive location information from a cellular phone tower and calculate the location of the device. Also, cell-tower location information unit may be used to calculate speed a device is travelling based on how quickly or slowly the device connects to a first cell tower and then disconnects from the first cell tower and, possibly connects to a second cell tower.

Similarly, a radio broadcast tower-based unit is configured to receive location information and calculate the location of the device.

A SIM-based location unit uses a subscriber identity module (SIM) in a device to obtain raw radio measurements from the handset and calculate the location of the device.

A hybrid location unit may employ one or more types of location methods to determine the location of the device.

Clearly, certain embodiments of a user detection element are configured to passively detect location information and/or motion information about the user. Analyzing the location information and/or motion information also may permit assessing the likelihood that user is in a vehicle or is traveling by vehicle. For example, a motion pattern in the sequence of “vehicle motion”, “stationary”, and then “foot motion” may indicate that the user has parked and exited the vehicle. The parking activity may also be detected directly from location and/or motion information, without the intervening step of detecting the mode of transportation. Such a motion pattern is termed a “parking motion pattern” for purposes of this application. When a “parking motion pattern” is detected with respect to a parking slot, then that parking slot is classified as “occupied”.

In contrast, a motion pattern in the sequence of “foot motion”, “stationary” and then “vehicle motion” may indicate that the user has entered the vehicle and removed it from the parking slot. This activity may also be detected directly from location and/or motion information, without the intervening step of detecting the mode of transportation. Such a motion pattern is termed a “deparking motion pattern” for purposes of this application. When a “deparking motion pattern” is detected with respect to a parking slot, then that parking slot is classified as “unoccupied”.

A motion pattern may be found by, for example, sensing or calculating the speed with which the user is moving and/or comparing the user's route with known geographic information about the geography of the environment. Geographic information may include street locations, maps, bus and train routes, parking lot maps, parking pay box locations, and building information.

Another motion pattern that may be significant includes “vehicle motion”, “stationary”, “foot motion”, “stationary”, and “foot motion”. Such a motion pattern, especially when compared with context information which shows that a parking pay box is located nearby the location in which the user was stationary for the second time, may indicate that a vehicle was parked and a parking payment was submitted.

A user detection element also may be configured to store information about a user's motion patterns such that, even before a motion pattern is received on a certain day or time, the system may predict the user's anticipated actions. For example, the system may ascertain that a user typically perform the same or similar motion patterns every weekday—that is a “weekday motion pattern”—and perform a second type of motion pattern weekend day (Saturday and Sunday)—that is, a “weekday motion pattern”. From these expected motion patterns, the system may analyze when the user is expected to use or leave certain parking slots or a parking slot in a certain area based on the day of the week or the user's typical schedule. Such weekday or weekend motion patterns may be used to calculate the parking availability estimation.

Another component—termed a vehicle proximity component—of certain embodiments of a user detection element is configured to assess when the user is close to a vehicle or otherwise perceive contact with a vehicle. Such a vehicle proximity component assists with assessing or confirming that the detection element is positioned in or near a vehicle and, accordingly, permits correlating detected location information with the location of the vehicle.

For example, a vehicle proximity component may include a first short distance communication element configured to exchange information with a second short distance communication element positioned in a vehicle. If the two communication elements are close enough to exchange information, it may be assumed that the user is positioned in a vehicle. Examples of a short distance communication element includes Bluetooth, WIFI, RFID, ZigBee, or other systems configured to permit wired or wireless communication generally only over a short distance. Embodiments of a vehicle proximity component also may include a physical connector to a vehicle, examples of which include a mini or micro USB cable or power cord, or other physical connector known in the art.

Another type of embodiment of a detection element is a vehicle detection element, which may be configured as part of the vehicle, rather than a generally portable element carried by the user. As an example, the vehicle detection element may be computer system or GPS-based location unit, each of which may be generally permanently positioned within or on the vehicle.

Yet another type of embodiment of a detection element is a resource detection element, which may be configured to detect payment information from a resource payment element (e.g., credit card payment box, payment software including pay by phone software, electronic parking meter, or other parking payment unit). Upon receipt of the information that payment has been received for a parking slot, payment information may be associated with a specific parking slot or set of parking slots to classify a slot as occupied or unoccupied. Additionally, the combination of payment information with information regarding the movement of an individual (or a vehicle) may be used to determine whether parking activity has occurred. For example, if a driver is detected as walking to a paybox or payment desk, staying there for a short time, and returning to the car, then it may be concluded that parking activity has occurred.

One or more embodiments of the detection element 102 may be configured to function together to permit identifying and verifying the status of whether a vehicle is occupying a parking slot or not. For example, in certain embodiments, a detection element includes a user detection element and a resource detection element. In such an embodiment, a user detection element may identify a parking motion pattern such as vehicle motion, stationary, walking motion, which leads to a determination that the vehicle is parked and the respective parking slot is occupied; or parking motion may be detected directly. In certain embodiments an acoustic detection element may be used. It can detect, for example, the sound of car-door closing or opening, and the sound of a car-engine starting. Each of these, separately or in combination, may indicate parking activity, and can be combined with other parking information. If additional information indicating that the user paid for a parking slot through the payment system is received, the determination that the user parked the vehicle is verified.

In another embodiment, the detection element may include a vehicle detection element and a resource detection element, each of which contributes detected information about the vehicle or the parking slot. Such detected information is processed to assess whether a parking slot is occupied or unoccupied.

After the detection element 102 perceives that a vehicle is likely occupying a parking slot, the detection element 102 sends such information to the synergization component 103. The synergization component 103 may store and analyze such detected information.

A number of detection elements 102 may submit detected information to the synergization component. Using the detected information, a record of which parking slots within a group of parking slots are occupied or unoccupied—termed “parking slot status information”—is generated by a resource availability estimation element 108 of the synergization component 103. Each record of parking slot status information collected over time may be stored in a background information element 106 within the synergization component 103.

Additional background information such as a historical availability profile and other past use information regarding individual parking slots or set of parking slots not obtained through detection element 102 also may be stored in a background information element 106. Non-detected information may come from independent surveys or analysis of how parking slots are used that are not generated by using the system. Any detected information or non-detected information may be used to calculate or verify parking slot status information.

The background information component 106 also may receive and store context information. For purposes of this application, the “context information” means at least geographic information, school calendars, federal holidays, religious holidays, and schedule information. Such information may be incorporated in the calculation of the parking availability estimation. For example, on a federal holiday that is also a weekday, parking slot usage may vary relative to a non-federal holiday weekday. This variation may be incorporated into the analysis. Also, parking restrictions, street cleaning schedules, and schedules of events such as baseball or football games or musical or theatrical performances or parades may be incorporated into the analysis.

Also, in certain embodiments, the parking slot status information is sent to the synergization component 103 regularly, e.g., every time a user inputs new information, every 1 minute, 5 minutes, 10 minutes, or other time interval.

In addition, as described above, parking slot status information may be attained from a source other than a detection element 102. For example, a parking slot or vehicle may have a permanent or semi-permanently mounted sensor configured to communicate with the synergization component.

In certain embodiments, the system 100 of the present invention is configured to rank a set of parking slots—e.g., a parking lot, street, block, or other grouping of parking slots—having the most unoccupied parking slots or complying with some other preference criteria. As described above, the ranking may be based on a parking availability estimation or desirability score.

Certain embodiments of the system 100 may incorporate into its ranking the nearness of several related spots. Accordingly, if, between the times the user submits a request for parking slot information or receives the system suggestion and when the user reaches the location of the parking slot, someone else takes the slot, then the user is more likely to be near another unoccupied slot. For example, if there is a single unoccupied slot on a block 0.2 miles away from the user's location and three unoccupied slots on a block in a different direction 0.3 miles away from the user's location, the system 100 may be configurable to rank the three slots higher than the single slot.

In certain embodiments, the output element 104 is configured to display visual or provide audio driving directions to the parking slot or parking lot ranked highest among the preference criteria or ranked most likely to be unoccupied. Such driving directions may be generated by a navigation element 112 of the synergization component 103.

Certain embodiments of a system 100 are configured to identify a preferred parking slot for each of a number of users. Such embodiments may incorporate group preference criteria, which may include maximizing the parking slot usage by all users as calculated by the lowest distance traveled for the group of users (not each individual user separately), lowest CO₂ emissions for the group of users, or lowest traffic congestion. In such embodiments, the synergization component 103 sends the output element 104 a suggestion of a preferred set of parking slots for each user to maximize the group use of the unoccupied parking slots.

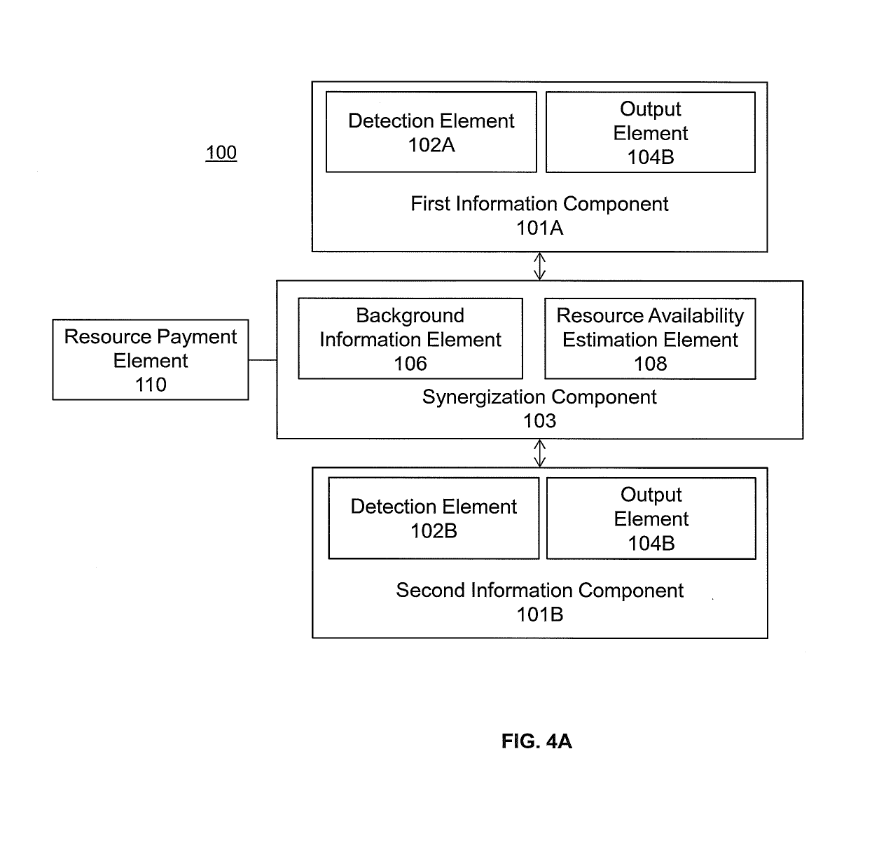

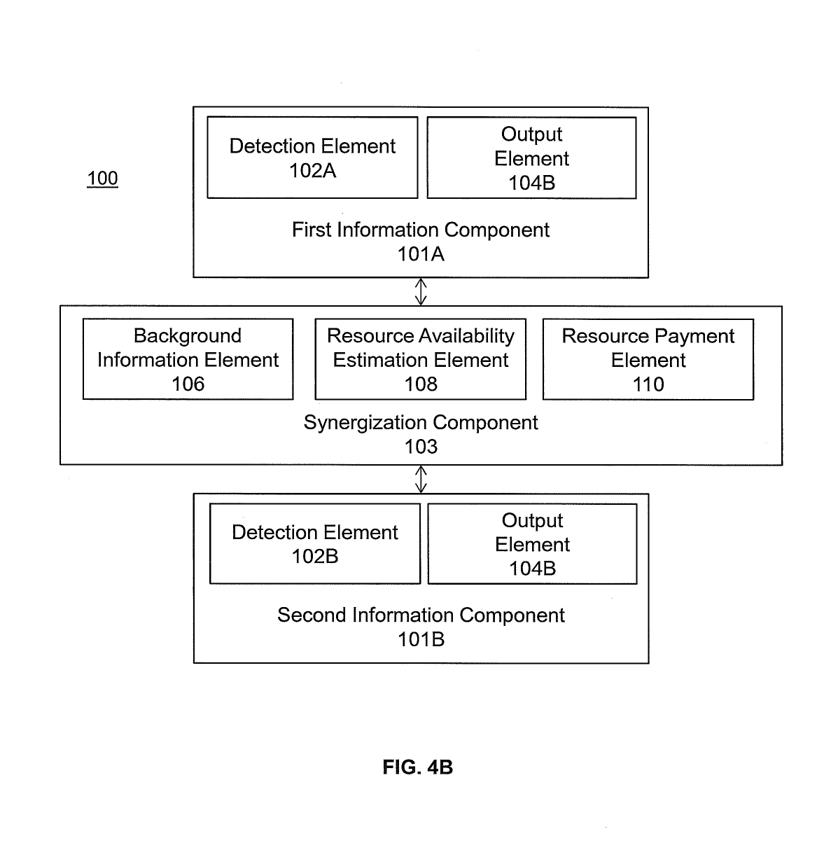

In certain embodiments configurable to manage group use of a set of unoccupied parking slots, the system 100 establishes the fee for each parking slot. Clearly, in such embodiments, a resource payment element 110—which permits the user to pay for a parking slot—is either in communication with the system 100 or a part of the system 100 as illustrated in FIG. 4A and FIG. 4B, respectively. Such embodiments may be controlled by or at least authorized by a central authority, e.g., an owner of a parking structure or other set of parking slots, city, town, municipality, co-op, or a group of users that has agreed to permit the system to select the price of the parking.

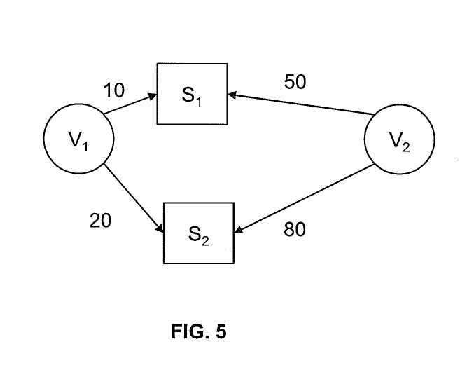

The fees may be adjusted to incentivize one or more users to park in slots more suitable or efficient for one or more members of or collectively the entire group, even when less efficient for certain of the users personally. Such efficiency may be measured according to a number of matching notions such as optimality and equilibrium. FIG. 5 illustrates an example of optimality. If the edge labels represent distances in one-hundredths of a mile, i.e., vehicle 1 (v1) is 0.1 miles from slot 1 (s1), i.e., v1 is 0.1 miles from s1, 0.2 miles from slot 2 (s2), and so forth, to achieve a minimum total. To achieve minimum total driving distance, i.e. System Optimum cost, v1 will have to park in s2, and v2 will have to park in s1. The total driving distance of this parking assignment, called SO, is 0.7 miles. However, this requires v1 to drive to a farther slot, s2, i.e., inferior from her point of view because s1 is closer. In certain situations, there may not be a central authority that can dictate this parking assignment to v1. If v1 drives to s1 (and captures it since she is closer than v2), then v2 must settle for s2. The total driving distance (cost) of this parking assignment, called NE, is 0.9=0.8+0.1 miles, i.e., higher than that of SO.

However, the property of the NE assignment is that no driver d can unilaterally deviate from NE and improve d's cost. The NE assignment is the Nash Equilibrium, and it is assumed that without a central authority to dictate parking assignments the system will naturally settle into it. The reason for this is that drivers generally act selfishly, and will lower their cost if they can do so. But this means that the total driving distance of the group of drivers in the system, and therefore congestion, will be higher.

As described above, the system 100 may be configured to provide an incentive—such as change the fees of the parking slots—to motivate users to park in the best slot for the entire group, rather than the best slot for that person individually. For example, continuing the scenario illustrated in FIG. 5, say, on average, driving 1 mile has a total $-cost of 50 cents (including gas, driver-time, vehicle wear-and-tear, etc.). Then, if the system 100 prices s1 at 15 cents and leaves s2 free, it will become better for v1 to park in s2, leaving s1 available for v2. Accordingly, the NE assignment in terms of $-cost+driving-distance, is the SO assignment is terms of driving distance. Clearly, when considering both $-cost+driving-distance, if each driver drives to the slot assigned to him or her by the SO assignment (i.e. the assignment that minimizes the total driving distance), she cannot unilaterally change her slot and improve her cost. Thus, by setting the fee, the system 100 made it worthwhile for each of the drivers in the group to travel a shorter distance in total.

In certain embodiments, the optimization fee may be above and beyond a normal hourly or daily price for parking. Also, a new optimization fee may be re-calculated every time a new parking slot becomes unoccupied, and therefore, available to receive a new vehicle, or may be re-calculated every time a new user requests that the system 100 assign or suggest a parking slot.

In other embodiments, the system 100 may have incomplete market penetration and, accordingly, may not have complete information about which users are seeking parking slots. In some such embodiments, the incentive establishing steps may include setting the incentive—such as a fee—for a single user (so there is no “known” competition for the most preferred slot) and such fee is configured to influence the user to park in a generally less congested area or in a less-used parking slot, even if there was a parking slot that was a more efficient match for the user's personal preference criteria.

While certain embodiments of the present invention result in different drivers paying different fees for the same parking slot, other embodiments permit compensating the drivers who drove a longer distance than the distance to the user's personally most preferred slot. Such embodiments may be revenue neutral or revenue generating.

Again, in the embodiment illustrated in FIG. 5, assuming that on average driving 1 mile has a total $-cost of 50 cents, then to enforce a vs-pricing scheme, the system 100 can set parking slot for v1 as an extremely large quantity for s1 and $0 for s2. For v2, the system 100 will set the prices as 0.3 miles for s1 and an extremely large quantity for s2. The 0.3 miles that v2 will have to pay converts to 15 cents. Then by setting these parking slot prices, the pricing authority incentivizes the drivers to choose slots according to the SO assignment (v1 to s2 and v2 to s1). By paying this price, i.e., 15 cents, v2 actually ends up paying the same amount (by adding $-cost and driving distance) that she would have paid had she gone to s2, as in the NE assignment. v1 pays more for her trouble, but the pricing authority can compensate her from the money that was collected from v2. The present invention may be configured to guarantee that the total payments collected from participating vehicles is at least as high as the compensation to participating vehicles.

Certain embodiments of the present invention are termed “PhonePark” for purposes of this application. In certain portions of this application, the motivations or choices of a driver/user is discussed in terms of the motivations or choices of a “vehicle”.

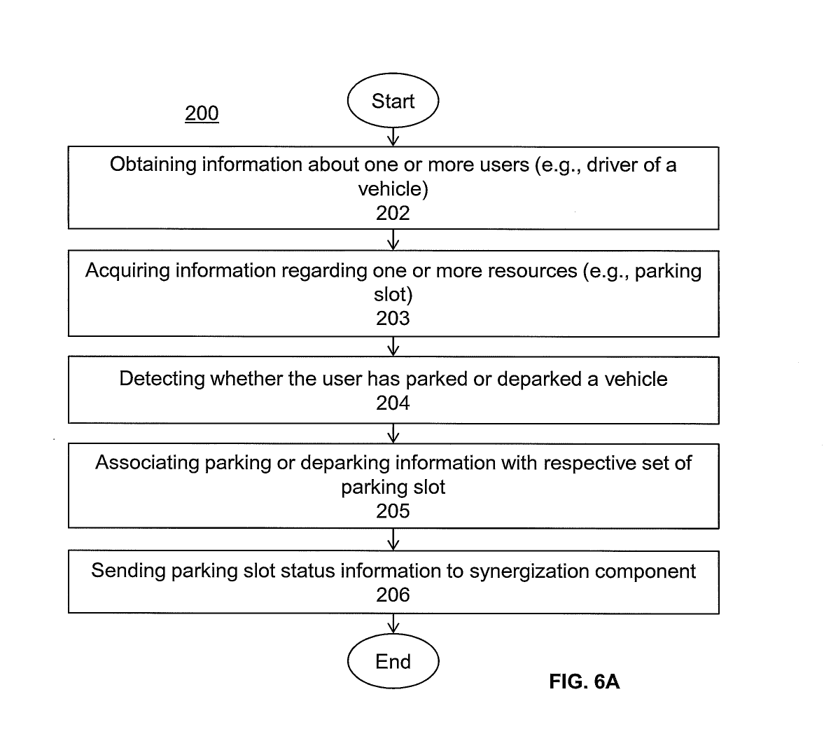

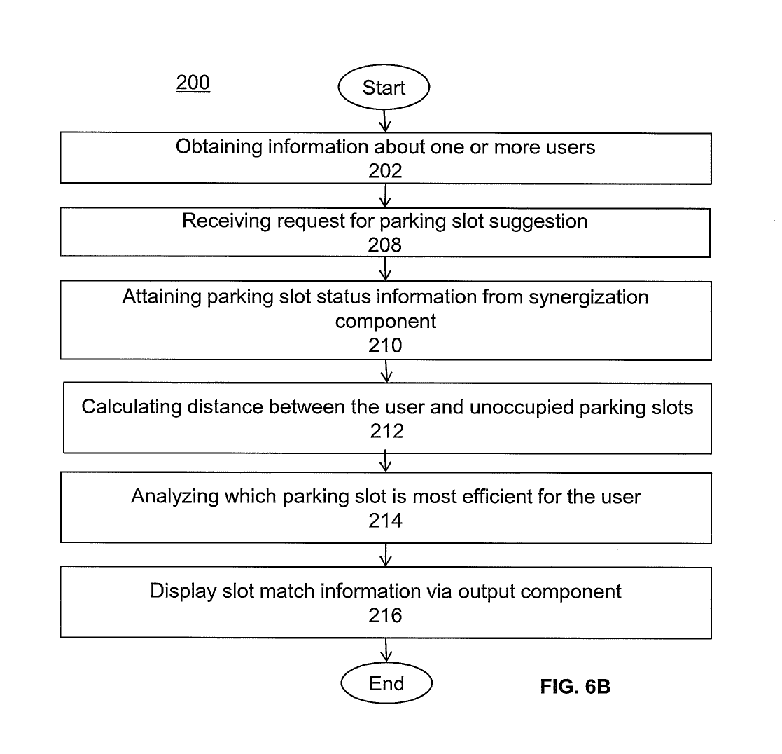

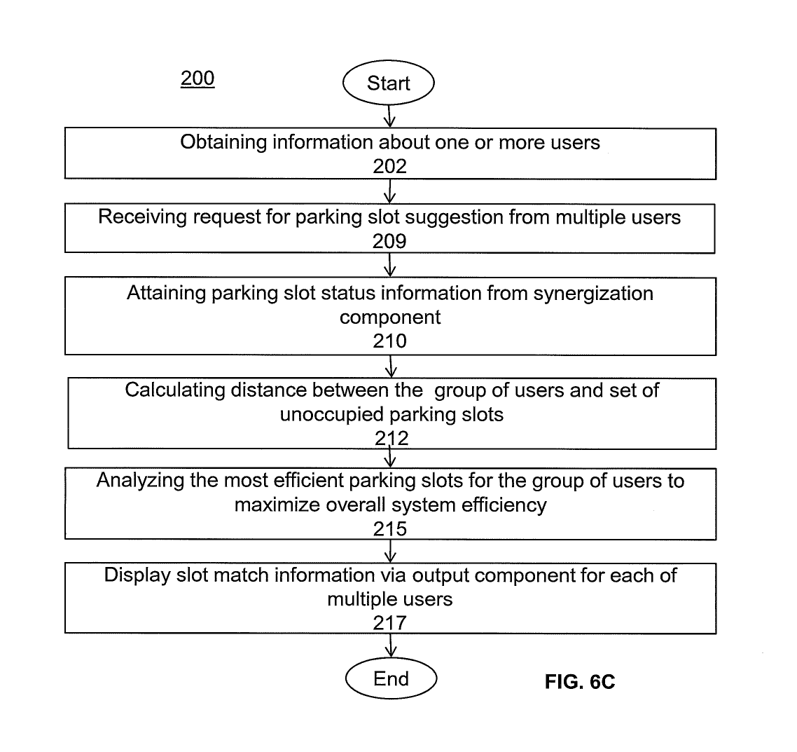

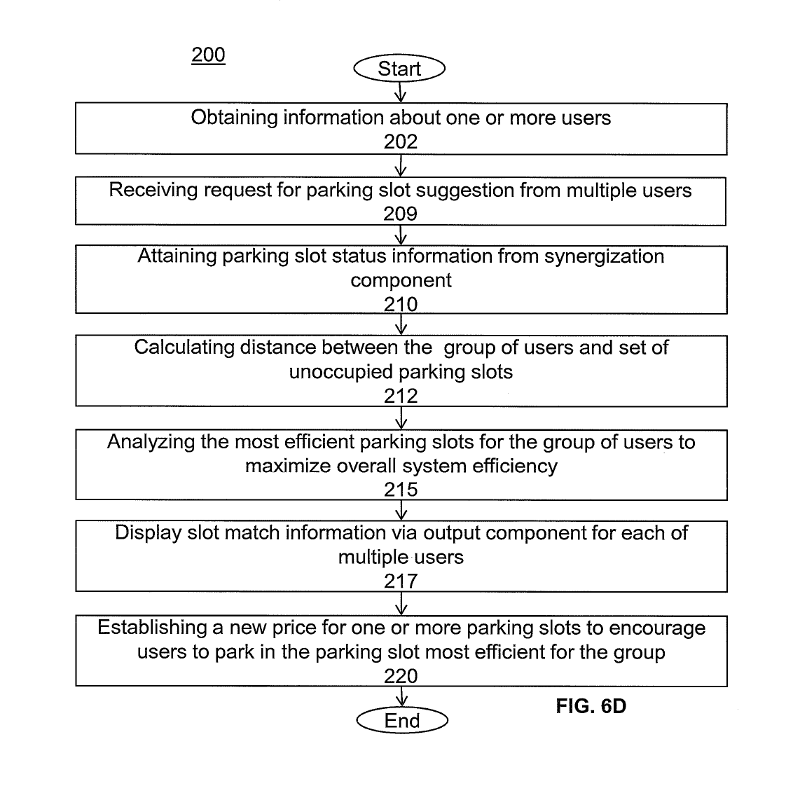

Certain embodiments of the present invention are configured as a method 200 implemented, at least in part, by, for example, a computer system 300. In certain embodiments, the method 200 steps illustrated in FIG. 6A include obtaining information about one or more users 202. This information about the users may include user profile information such as the user's name, email address, mailing address, and detection element associated with the user (e.g., mobile smartphone).

In addition, certain embodiments of the system acquire information regarding one or more resources (e.g., a map of the parking slots in a lot, neighborhood, city, region, etc.) 203.

The system may then detect whether the user is nearby a vehicle and whether that vehicle has been parked or deparked 204. Upon receipt of information that a user has parked or deparked a vehicle, such information is associated with the set of parking slots closest to the location at which the parked or deparked status was detected 205. Such parking slot status information is sent to the synergization component 206.

An additional embodiment is illustrated in FIG. 6B. In this embodiment, another user may request a parking slot suggestion, with or without preference criteria 208. The parking lot status information—that is, which slots in which locations are occupied or unoccupied—received from previous users or otherwise computed is attained 210. The distance between the user and the unoccupied slots is calculated 212. An analysis is done to determine the most preferred parking slot for the user 214. Any mandatory or optional individual preference criteria or group preference criteria may be incorporated into the analysis regarding the efficiency of choosing each unoccupied parking slot. Such analysis may include ranking the unoccupied slots. At least information about the best matching slot is sent to an output element to be displayed for the user 216.

Another embodiment is illustrated in FIG. 6C and may be adapted for multiple users. For example, the analysis step may include matching each of multiple users with each of multiple unoccupied parking slots.

The embodiment illustrated in FIG. 6D includes an additional step of establishing a new price for one or more parking slots to influence users to park in the parking slot most preferred for the group as a whole.

Other method steps may include providing a user interface configured to permit a user to input preference criteria and request a parking slot suggestion based on such criteria.

Certain embodiments may also include steps dedicated to assessing whether the group preferences for many users align with the individual preferences. When such group preferences do not align with the individual preferences, an incentive or disincentive—such as one based on a fee—for each of one or more parking slots may be adjusted. Such new fee is dispatched to a payment element and the user is asked to pay the new fee in order to legally park in the slot. The resource payment element may exchange information with other elements of the system, for example, to assist with determining whether a vehicle has parked in a slot or to assess an appropriate fee for that slot. Certain embodiments are configurable so that the total amount of money each person pays for parking does not exceed a certain pre-selected threshold. The threshold may be determined by the overall configuration of users and parking slots. The thresholds provided to the users may be configured such that the total $-payments received from users are not lower than the total $-payments paid out to users.

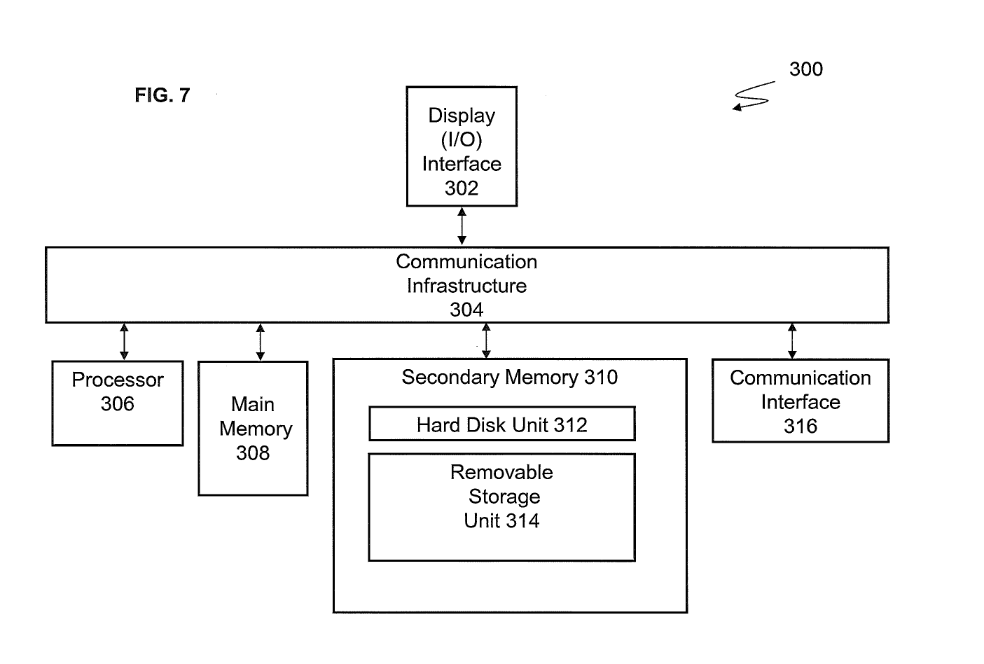

FIG. 7 illustrates an exemplary computer system 300 that may be used to implement the methods according to the invention. One or more computer systems 300 may carry out the methods presented herein as computer code.

Computer system 300 includes an input/output display interface 302 connected to communication infrastructure 304—such as a bus—, which forwards data such as graphics, text, and information, from the communication infrastructure 304 or from a frame buffer (not shown) to other components of the computer system 300. The input/output display interface 302 may be, for example, a keyboard, touch screen, joystick, trackball, mouse, monitor, speaker, printer, any other computer peripheral device, or any combination thereof, capable of entering and/or viewing data.

Computer system 300 includes one or more processors 306, which may be a special purpose or a general-purpose digital signal processor that processes certain information. Computer system 300 also includes a main memory 308, for example random access memory (“RAM”), read-only memory (“ROM”), mass storage device, or any combination thereof. Computer system 300 may also include a secondary memory 310 such as a hard disk unit 312, a removable storage unit 314, or any combination thereof. Computer system 300 may also include a communication interface 316, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 308, secondary memory 310, communication interface 316, or a combination thereof, function as a computer usable storage medium, otherwise referred to as a computer readable storage medium, to store and/or access computer software including computer instructions. For example, computer programs or other instructions may be loaded into the computer system 300 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software including computer instructions may be transferred from the removable storage unit 314 or hard disc unit 312 to the secondary memory 310 or through the communication infrastructure 304 to the main memory 308 of the computer system 300.

Communication interface 316 allows software, instructions and data to be transferred between the computer system 300 and external devices or external networks. Software, instructions, and/or data transferred by the communication interface 316 are typically in the form of signals that may be electronic, electromagnetic, optical or other signals capable of being sent and received by the communication interface 316. Signals may be sent and received using wire or cable, fiber optics, a phone line, a cellular phone link, a Radio Frequency (“RE”) link, wireless link, or other communication channels.

Computer programs, when executed, enable the computer system 300, particularly the processor 306, to implement the methods of the invention according to computer software including instructions.

The computer system 300 described herein may perform any one of, or any combination of, the steps of any of the methods presented herein. It is also contemplated that the methods according to the invention may be performed automatically, or may be invoked by some form of manual intervention.

The computer system 300 of FIG. 7 is provided only for purposes of illustration, such that the invention is not limited to this specific embodiment. It is appreciated that a person skilled in the relevant art knows how to program and implement the invention using any computer system.

The computer system 300 may be a handheld device and include any small-sized computer device including, for example, a personal digital assistant (“PDA”), smart hand-held computing device, cellular telephone, or a laptop or netbook computer, hand held console or MP3 player, tablet, or similar hand held computer device, such as an iPad®, iPad Touch® or iPhone®.

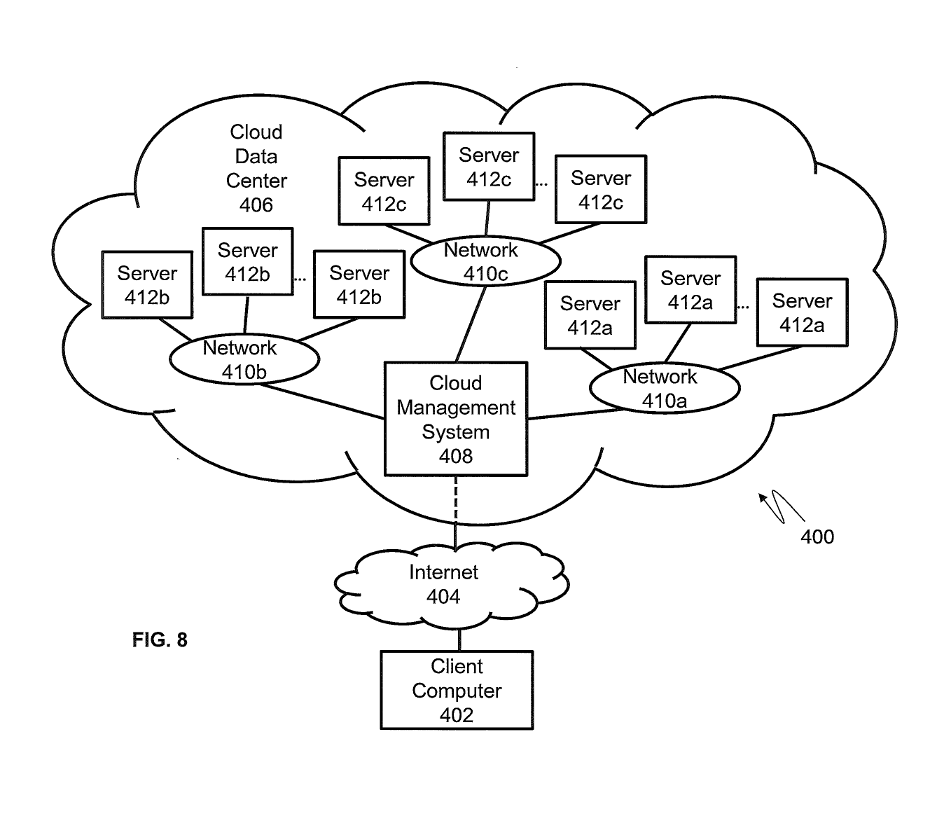

FIG. 8 illustrates an exemplary cloud computing system 400 that may be used to implement the methods according to the present invention. The cloud computing system 400 includes a plurality of interconnected computing environments. The cloud computing system 400 utilizes the resources from various networks as a collective virtual computer, where the services and applications can run independently from a particular computer or server configuration making hardware less important.

Specifically, the cloud computing system 400 includes at least one client computer 402. The client computer 402 may be any device through the use of which a distributed computing environment may be accessed to perform the methods disclosed herein, for example, a traditional computer, portable computer, mobile phone, personal digital assistant, tablet to name a few. The client computer 402 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 402 also includes a communications interface, for example, a modem, a network interface (such as an Ethernet card), a communications port, a PCMCIA slot and card, wired or wireless systems, etc. The communications interface allows communication through transferred signals between the client computer 402 and external devices including networks such as the Internet 404 and cloud data center 406. Communication may be implemented using wireless or wired capability such as cable, fiber optics, a phone line, a cellular phone link, radio waves or other communication channels.

The client computer 402 establishes communication with the Internet 404—specifically to one or more servers—to, in turn, establish communication with one or more cloud data centers 406. A cloud data center 406 includes one or more networks 410a, 410b, 410c managed through a cloud management system 408. Each network 410a, 410b, 410c includes resource servers 412a, 412b, 412c, respectively. Servers 412a, 412b, 412c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 408 can comprise a dedicated or centralized server and/or other software, hardware, and network tools to communicate with one or more networks 410a, 410b, 410c, such as the Internet or other public or private network, with all sets of resource servers 412a, 412b, 412c. The cloud management system 408 may be configured to query and identify the computing resources and components managed by the set of resource servers 412a, 412b, 412c needed and available for use in the cloud data center 406. Specifically, the cloud management system 408 may be configured to identify the hardware resources and components such as type and amount of processing power, type and amount of memory, type and amount of storage, type and amount of network bandwidth and the like, of the set of resource servers 412a, 412b, 412c needed and available for use in the cloud data center 406. Likewise, the cloud management system 408 can be configured to identify the software resources and components, such as type of Operating System (“OS”), application programs, and the like, of the set of resource servers 412a, 412b, 412c needed and available for use in the cloud data center 406.

The present invention is also directed to computer products, otherwise referred to as computer program products, to provide software to the cloud computing system 400. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 400 of FIG. 8 is provided only for purposes of illustration and does not limit the invention to this specific embodiment. It is appreciated that a person skilled in the relevant art knows how to program and implement the invention using any computer system or network architecture.

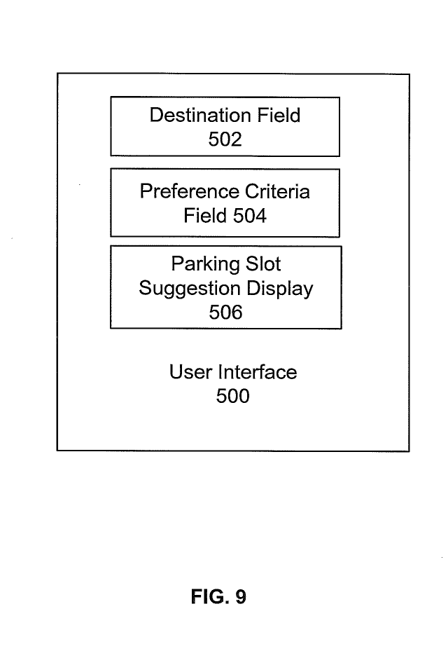

FIG. 9 illustrates one embodiment of a user interface 500 according to the system of the present invention. The illustrated embodiment includes two user input fields—specifically, a destination field 502 and a preference criteria field 504—, and a parking slot suggestion display 506.

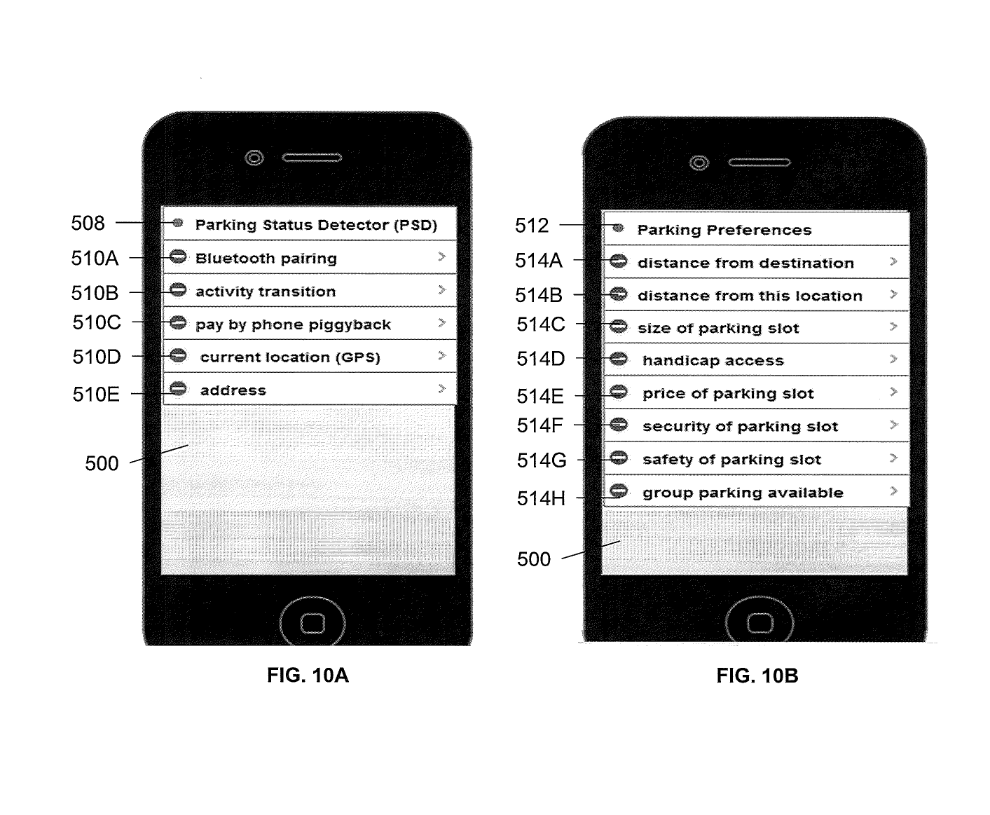

FIG. 10A illustrates another embodiment of a user interface 500 according to the system of the present invention. The illustrated embodiment includes a parking status detector menu 508, which includes various parking status menu items 510. For example, a Bluetooth pairing element 510A may be the user interface element for managing a short distance communication element. An embodiment of a user interface that permits a user to select the Bluetooth device that will be monitored for Bluetooth connectivity detection is shown in FIG. 11. An activity transition element 510B may be configured to permit detecting, sensing, or reporting motion patterns in the user interface 500. A pay by phone piggyback element 510C may be configured to permit viewing information about a resource payment element 110 in the user interface 500. A current location (GPS) element 510D may permit the user to enter or view information about the user's location in the user interface 500 and, possibly, search for parking slots or slot suggestions available near that location. An address element 510E may permit the user to enter, identify, or view a neighborhood, a building, stadium, or other geographical descriptor including an address, e.g., of the destination and, possibly, search for parking slots or slot suggestions available at or near that which is identified.

FIG. 10B illustrates an embodiment of a parking preferences menu 512, which includes various parking preferences menu items 514. Such preference menu items include those shown in FIG. 10B: distance from destination 514A; distance from location 514B; size of parking lot 514C; handicap accessibility 514D; price of parking slot 514E; security of parking slot 514F; safety of parking slot 514G; and, group parking availability 514H. For example, each menu item 514 may be configured to permit a user to enter or view information related to his or her preferences about a parking slot it seeks to find and the relative importance of these preferences.

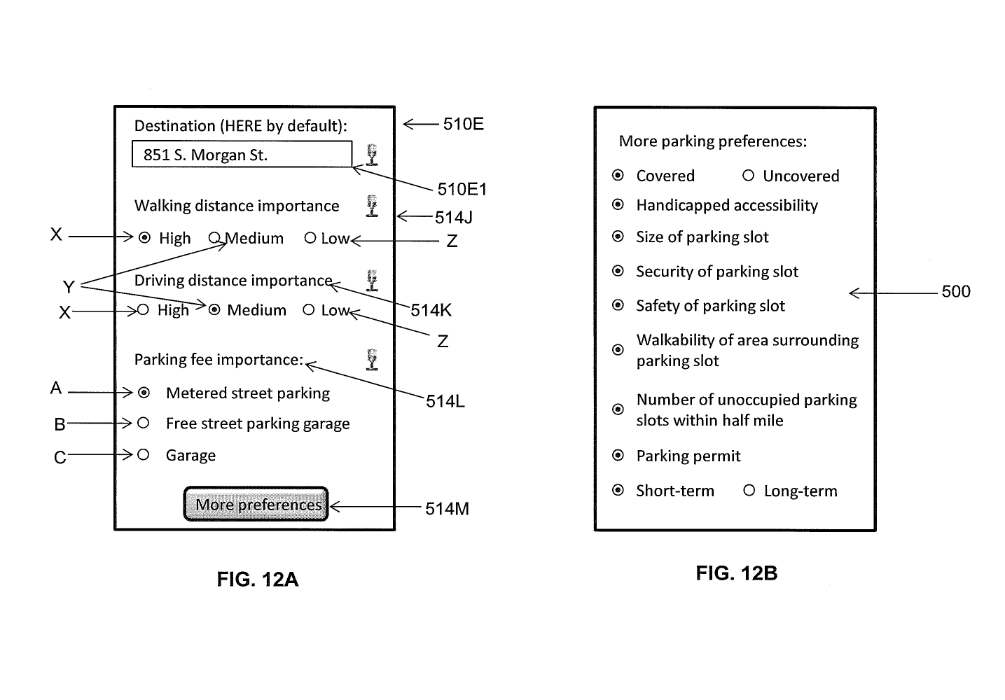

FIG. 12A illustrates another embodiment of a user interface 500. The FIG. 12 embodiment includes an address element 510E—bearing the illustrative text “Destination (HERE by default):” and an query box 510E1—into which the illustrative text “851 S. Morgan St.” is entered—that permits a user to enter, identify, or view a neighborhood, a building, stadium, or other geographical descriptor including an address, e.g., of their destination in order to search for parking slots or slot suggestions available at or near that which is identified address. The FIG. 12A embodiment also includes a parking preferences menu 512, that includes various parking preferences menu items 514 that permit a user to configure the system so as to select for or view information related to his or her preferences about a parking slot and the relative importance of these preferences. The FIG. 12A embodiment illustrates variations of the “distance from destination” 514A and “distance from this location” 514B components shown in the FIG. 10B embodiment as a “walking distance importance” component 514J and a “Driving distance importance” 514K that allows a user to rank how important it is to walk or drive only a certain relative amount of distance. The rankings—“High”, Medium” and “Low” and identified as “X”, “Y”, and “Z”—are merely illustrative of the number and variety of such selections that can be included to identify more closely the user's preferences. The FIG. 12A embodiment includes also a “Parking fee importance” component 514L that allows a user to select which of certain factors are important in choosing the parking slot relative to the fee charged. Illustrated are “Metered street parking”, “Free street parking garage”, and “Garage”—identified as “A”, “B”, and “C”. The user interface shown in FIG. 12A embodiment also includes a “digital button” 514M that permits a user to select for “More preferences”.

FIG. 12B illustrates an embodiment of a user interface 500 identified as “More parking preferences” and showing some of the many additional preferences that the system may include to permit a user to configure the selection process.

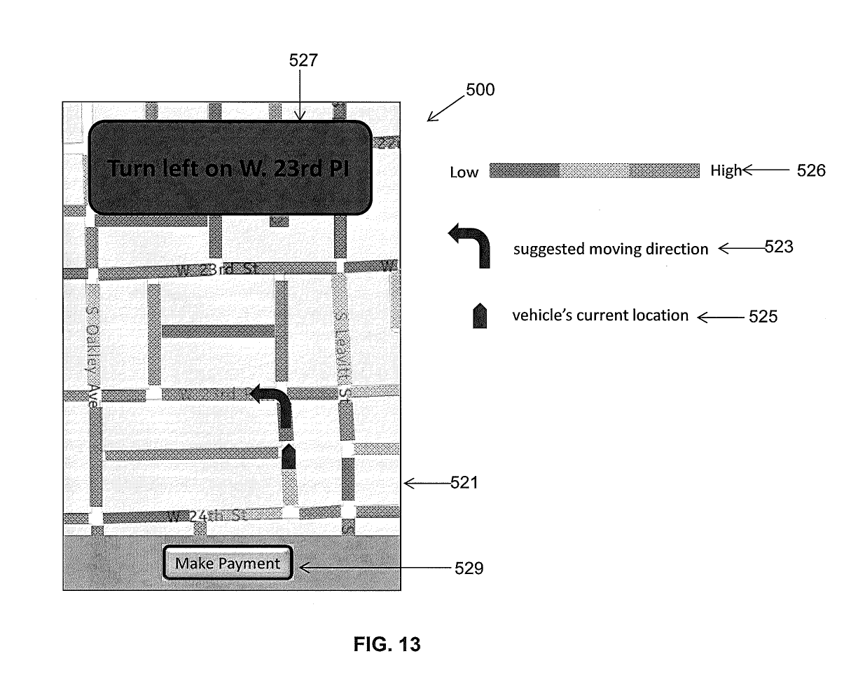

FIG. 13 illustrates an embodiment of a user interface 500 that provides easy to discern navigation suggestions 523 and the vehicle's current location 525 juxtaposed over a stylized map of an area 521. The embodiment may include an easy to discern graphical element 526 that identifies to a user the likelihood of finding parking by colors or other designations. The embodiment can include a visual display of suggested navigation 527 (and/or an aural communication of same—not shown) and a “digital button”—identified as “Make Payment” 529—that permits the user to make a payment for parking—either in advance to reserve parking or in real time at the time of parking.

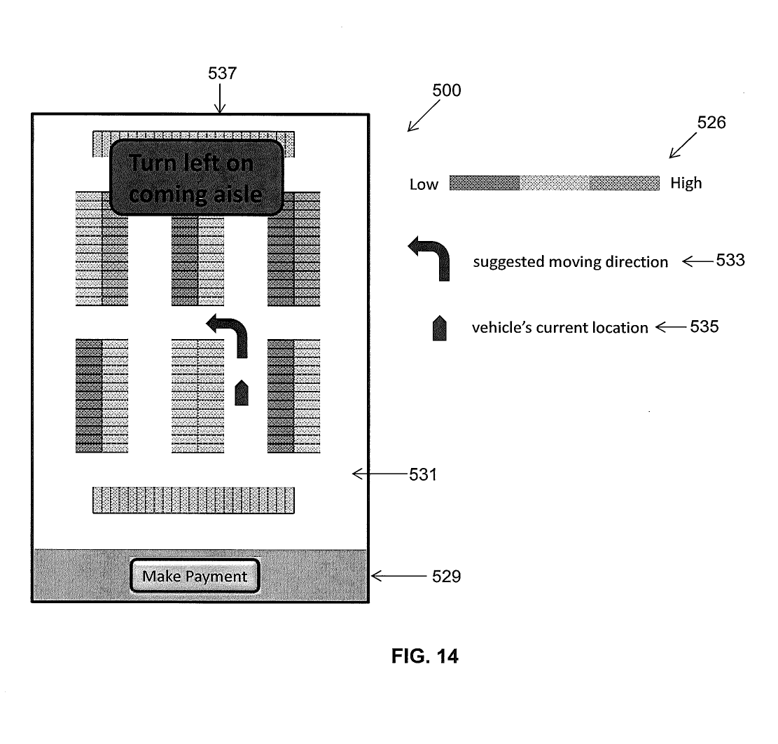

FIG. 14 illustrates another embodiment of a user interface 500 that provides easy to discern parking lot navigation suggestions 533 and the vehicle location within a parking lot 535 juxtaposed over a stylized map of a parking lot 531. The embodiment may include an easy to discern graphical element 526 that identifies to a user the likelihood of finding parking by colors or other designations. The embodiment can include a visual display of suggested parking lot navigation 537 (and/or an aural communication of same—not shown) and a “digital button”—identified as “Make Payment” 529—that permits the user to make a payment for parking—either in advance to reserve parking or in real time at the time of parking.

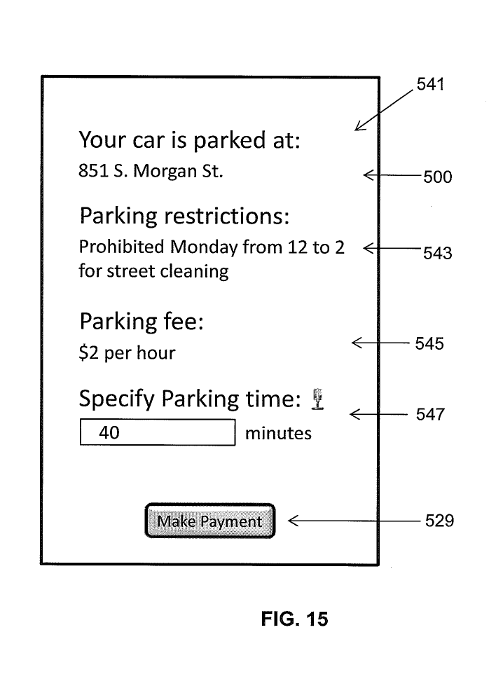

FIG. 15 illustrates an additional embodiment of a user interface 500 that provides details of the parking resource and permits a user to make a payment according to the user's entered information. The FIG. 15 embodiment includes a parking reminder 541 by which the location where the user's vehicle is parked is memorialized, parking restriction information 543, the parking fee 545, the parking time 547 that the user wishes to park, and a “Make Payment” 529 digital button that when activated allows the user to pay for the designated parking electronically.

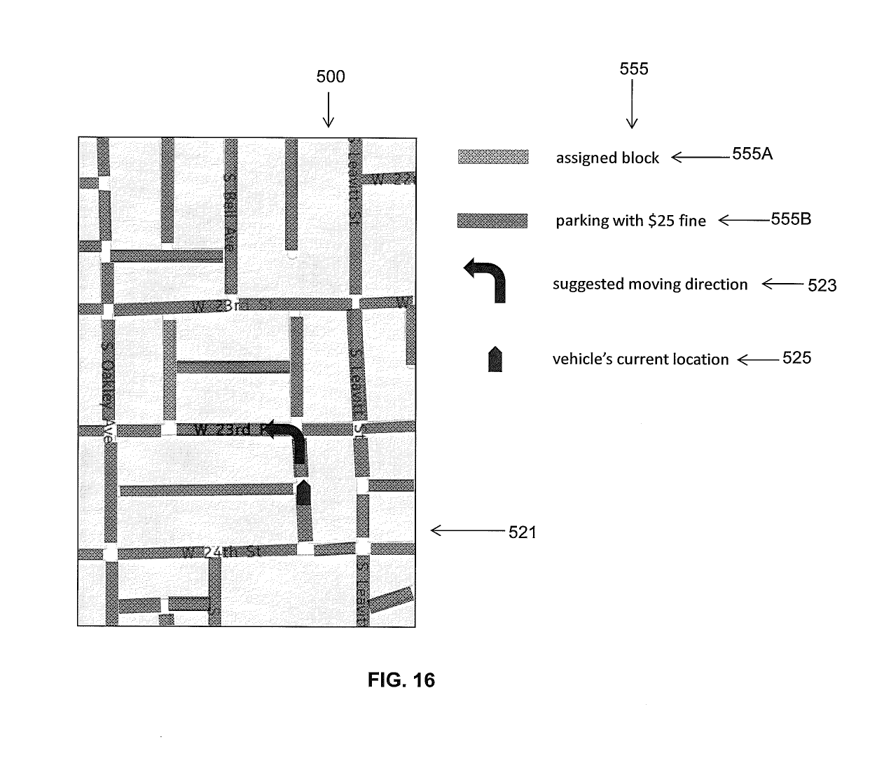

FIG. 16 illustrates an added embodiment of a user interface 500 that provides easy to discern navigation suggestions 523 and the vehicle's current location 525 juxtaposed over a stylized map of an area 521. While the embodiment may include one or more of the components that are included in the FIG. 13 embodiment, the FIG. 16 embodiments easy to discern graphical features 555 that identifies to a user what block of a neighborhood the user has a permit for parking—identified as “assigned block” 555A—and the areas in which the user will pay a certain fine for parking—identified as “parking with $25 fine” 555B.

While the disclosure is susceptible to various modifications and alternative forms, specific exemplary embodiments of the present invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A system for maximizing efficient utilization of a resource by one or more users, comprising:
a processor;
a main memory in communication with the processor via a communication infrastructure and storing instructions that, when executed by the processor, cause the processor to:
acquire information about the resource to determine whether one resource or a group of resources are available or unavailable;
detect an event in which an unavailable one resource or the group of resources becomes available; and
communicate the availability or the unavailability of the one resource or the group of resources to the one or more users whereby the efficient utilization of the one resources or the group of resources may be maximized.

2. A system for maximizing efficient utilization of one or more parking slots by one or more users seeking to park one or more vehicles, comprising:
a processor;
a main memory in communication with the processor via a communication infrastructure and storing instructions that, when executed by the processor, cause the processor to:
acquire information about the locations of one or more parking slots;
group one or more parking slots into two or more sets of parking slots;
detect an event in which one or more users has parked or deparked the one or more vehicles in the locations;
associate the event in which the one or more users parked or deparked the one or more vehicles to form parking slot status information; and
communicate the parking slot status information to the one or more users whereby the efficient utilization of the one or more parking slots may be maximized.

3. The system of claim 2, wherein the detect step includes receiving detected information indicating that one or more of the following types of events occurred:
a. a short distance communication element pairs with a vehicle short distance communication element,
b. a short distance communication element breaks the pairing with a vehicle short distance communication element,
c. a payment for a parking slot is made for a specific parking slot or some parking slot within a set of parking slots,
d. a motion pattern associated with paying is detected,
e. a parking motion pattern or a deparking motion pattern is detected, or
f. an acoustic signal associated with parking has been detected.

4. The system of claim 2, wherein the main memory in communication with the processor stores instructions that, when executed by the processor, cause the processor also to develop a historical availability profile for at least one of the two or more sets of parking slots using detected information from the one or more users or non-detected information from another source.

5. The system of claim 4, wherein the developed historical availability profile step is comprised of establishing a parking availability value and incorporating a scaled decrease of the parking availability if the system does not have a complete market penetration.

6. The system of claim 5, wherein the developed historical availability profile step also is comprised of adding a scaled increase or decrease to the parking availability value to adjust for possible false positives or false negatives in the detected information.

7. The system of claim 4, wherein the main memory in communication with the processor stores instructions that, when executed by the processor, cause the processor also to compute a parking availability estimation for the at least one of the two or more sets of parking slots, wherein the compute step employs at least one of:
a. Historical Statistics method;
b. Scaled PhonePark method;
c. Weighted Average method; or
d. Kalman Filter method.

8. The system of claim 7, wherein the main memory in communication with the processor stores instructions that, when executed by the processor, cause the processor also to accept a request for parking slot suggestion from at least one of the one or more users, wherein the request includes one or more personal preference criteria.

9. The system of claim 8, wherein the one or more personal preference criteria include one or more of the following:
a. shortest distance from user current location;
b. shortest distance from user destination;
c. fee associated with parking slot;
d. handicapped accessibility;
e. size of parking slot;
f. security of parking slot;
g. safety of parking slot;
h. walkability of area surrounding parking slot;
i. number of unoccupied parking slots within a certain radius;
j. whether the user has any type of permit for parking slots;
k. short-term parking or long-term parking; or
l. covered or uncovered parking slot.

10. The system of claim 9, wherein the request includes four or more personal preference criteria.

11. The system of claim 8, wherein the main memory in communication with the processor stores instructions that, when executed by the processor, cause the processor also to combine the one or more personal preference criteria with the parking availability estimation to make a personal desirability score for the at least one of the two or more sets of parking slots and rank the two or more sets of parking slots according to the personal desirability score.

12. The system of claim 11, wherein the main memory in communication with the processor stores instructions that, when executed by the processor, cause the processor also to display a parking slot suggestion, wherein the parking slot suggestion is selected based on highest personal desirability score.

13. The system of claim 12, wherein the main memory in communication with the processor stores instructions that, when executed by the processor, cause the processor also to display at least two or more parking slot suggestions and show the personal desirability score associated with each parking slot suggestion.

14. The system of claim 12, wherein the main memory in communication with the processor stores instructions that, when executed by the processor, cause the processor also to emit audible directions to the location of a parking slot identified the parking slot suggestion.

15. The system of claim 2, wherein the main memory in communication with the processor stores instructions that, when executed by the processor, cause the processor also to:
accept a request for a parking slot suggestion from at least one or more users,
apply one or more group preference criteria selected from minimizing distance traveled to the parking slot for two or more users, minimizing pollution, or minimizing traffic congestion,
incorporate the one or more group preference criteria with the parking availability estimation to make a group desirability score for the at least one of the two or more sets of parking slots and rank the two or more sets of parking slots according to the group desirability score,
pick a group parking slot suggestion for the user based on highest group desirability score, and
present the group parking slot suggestion via an output element.

16. The system of claim 15, wherein the main memory in communication with the processor stores instructions that, when executed by the processor, cause the processor also to setting a fee for at least one parking slot, thereby incentivizing the user to park in the parking slot presented in the group parking slot suggestion or deincentivizing the user from parking in a parking slot other than the parking slot presented in the group parking slot suggestion.

17. The system of claim 16, wherein the fee-setting step includes revenue-neutral pricing strategy among all of the one or more fees established by the system.

18. The system of claim 16, wherein the fee-setting step ensures that the fees collected from drivers exceed the discounts or refunds provided to drivers.

19. The system of claim 18, wherein the ensuring step is provided via the guarantee that the system optimum is better overall than the equilibrium.

20. The system of claim 16, wherein the fee-setting step includes a revenue-generating pricing strategy among all of the one or more fees established by the system.

21. A cloud computing system for maximizing resource utilization by one or more users, comprising:
a first client computer comprising a first processor and a first main memory in communication with the first processor via a communication infrastructure and storing instructions that, when executed by the first processor, cause the first processor to:
gather information about whether a parking slot is occupied or unoccupied using a detection unit, wherein such information forms detected information; and
send the detected information to a server;
wherein the server comprises a second processor and a second main memory in communication with the second processor via the communication infrastructure and storing instructions that, when executed by the second processor, cause the second processor to:
get the detected information from the client computer; and
generate a parking availability estimation based on the detected information.

22. The cloud computing system of claim 21, wherein the first main memory in communication with the first processor stores instructions that, when executed by the first processor, cause the first processor also to:
provide a user interface through which a user can prepare and submit a request for a parking slot suggestion, wherein the request for a parking slot suggestion includes one or more preference criteria fields configured to permit the user to enter preference criteria and wherein the user interface is configured to be at least observed through an output element; and
present parking slot suggestions based on the parking availability estimation.

23. The cloud computing system of claim 21 where the parking availability is updated based on the location where the vehicle requesting a parking slot suggestion stops and parks.

24. The cloud computing system of claim 21 where the parking availability is updated based on a request for a parking location reminder or on a parking-time expiration alert.
